(19) United States
(12) Patent Application Publication
(10) Pub. No.: US 2023/0284343 A1
(43) Pub. Date: Sep. 7, 2023

(54) Transparent Conformable Resistive Heating Element

(71) Applicant: Chasm Advanced Materials, Inc., Canton, MA (US)

(72) Inventors: Manasi Chaubal, Dorchester, MA (US); David J. Arthur, Braintree, MA (US)

(21) Appl. No.: 18/115,874

(22) Filed: Mar. 1, 2023

Related U.S. Application Data
(60) Provisional application No. 63/316,977, filed on Mar. 5, 2022.

(51) Int. Cl. H05B 3/34

(52) U.S. Cl. CPC H05B 3/34

(57) ABSTRACT

A transparent conformable resistive heating element that is configured to be coupled to a structure to be heated to a predetermined heating range including a transparent conformable substrate with a lower surface that is configured to be coupled to the structure to be heated and an opposed upper surface, wherein the substrate is stable across the predetermined heating range, a layer of dried carbon nanotube (CNT) transparent conductive ink on at least some of the upper surface of the substrate, wherein the transparent conductive ink is stable across the predetermined heating range, and a pair of spaced electrodes each in electrical contact with the transparent conductive ink layer.

### CROSS-REFERENCE TO RELATED APPLICATION

This application claims priority of Provisional Application 63/316,977 filed on Mar. 5, 2022, the entire disclosure of which is incorporated by reference herein and for all purposes.

### BACKGROUND

This disclosure relates to a transparent heater.

A transparent and conformable heater can be used to control the temperature of a reactor vessel. Heater operation at elevated temperatures (e.g., up to about 200° C.) can be required. In some cases, the heaters must have a visible light transparency (VLT) of greater than about 60%, for example when a process is being monitored with a camera.

### SUMMARY

Aspects and examples are directed to a transparent and conformable heater with a transparent conformable substrate, a layer of dried carbon nanotube (CNT) transparent conductive ink on at least some of a surface of the substrate, and a pair of spaced electrodes each in electrical contact with the transparent conductive ink layer.

All examples and features mentioned below can be combined in any technically possible way.

Featured in this disclosure is a transparent conformable resistive heating element that is configured to be coupled to a structure to be heated to a predetermined heating range, including a transparent conformable substrate with a lower surface that is configured to be coupled to the structure to be heated and an opposed upper surface, wherein the substrate is stable across the predetermined heating range, a layer of dried carbon nanotube (CNT) transparent conductive ink on at least some of the upper surface of the substrate, wherein the transparent conductive ink is stable across the predetermined heating range, and a pair of spaced electrodes each in electrical contact with the transparent conductive ink layer.

The substrate should have sufficient optical clarity as needed to achieve at least a minimum overall transparency of the heating element. The substrate should also be configured to accept and maintain the conductive coating that is created on the substrate surface and acts as a resistive heating element. The substrate also needs to be configured to be able to be coupled to the surface to be heated. The substrate should also be stable across the expected temperature operating range.

In examples the substrate is made from one or more of silicone, polyimide, cyclic olefin polymer (COP), polyethersulfone, thermoplastic polyurethane (TPU), and polyethylene naphthalate (PEN). In an example the upper surface of the substrate is modified to improve its wetting characteristics. In an example the upper surface of the substrate is modified by corona treatment. In an example the upper surface of the substrate has a sheet resistance of less than 2000 ohms per square and a contact angle of at least about 15 degrees.

In an example the concentration of CNT in the ink is between about 0.6 g/l and about 2 g/l. In an example the transparent conductive ink layer has at least one of: a sheet resistance of about 500 to about 3000 ohms per square, a thickness of between about 50 nm and about 300 nm, and a visible light transmittance (VLT) of at least about 60%.

In an example the transparent conformable resistive heating element also includes an adhesive on the lower surface of the substrate. In an example the adhesive is optically clear. In an example the VLT of the adhesive is from about 85% to about 99%. In an example the substrate has a VLT of from about 85% to about 95%. In an example the transparent conductive ink layer has a VLT of from about 60% to about 80%.

In an example the transparent conformable resistive heating element has a VLT of at least about 50%. In an example the predetermined heating range is up to about 200° C. In an example the predetermined heating range is achieved using a variable 220V power supply. In an example the electrodes are on top of the transparent conductive ink. In an example the transparent conformable resistive heating element also includes an optically clear silicone cover layer over the transparent conductive ink layer.

In some examples the subject transparent and conformable heater is used to control the temperature of a glass reactor vessel. Elevated temperatures are required (up to 200° C.) and visible light transparency (VLT) of greater than 60% is required for camera monitoring of the reactor.

A CNT ink was formulated and printed onto a high-temperature, optically-clear silicone substrate. Due to poor wetting characteristics of silicone, the silicone surface was modified via corona treatment before printing CNT ink. Silver busbars were then printed on top of the CNT ink and a silicone optically-clear adhesive cover film was subsequently laminated on top of CNT ink layer to create a CNT/silicone heater film. This conformable CNT/silicone heater film was then laminated to a glass sheet to create a working heater prototype for heater performance testing. Another version of this conformable heater (without busbars) was laminated to a cylindrical glass tube (reactor vessel) to demonstrate conformability of the transparent heater film. See FIG. 2, described below.

An exemplary heater meets the following specifications: the heater can achieve target temperature of 200° C. at maximum available power of 220 VDC. Voltage can be varied to set the temperature on heater as required. Visible light transmission of the heater stack (including OCA and silicone substrate) is 62.6%. It was possible to laminate heaters across the surfaces of the reactor vessel (two cylindrical areas and one circular bottom area) which proves that heaters are conformable.

Advantages of this invention include: the heater is transparent, it can be manufactured by standard techniques such as screen printing, it can achieve and operate at temperatures as high as 200° C., it efficiently produces heat as energy, it is resistant to harsh environmental conditions (high humidity, corrosive environment, or heat), and it uses a novel formulation of the carbon nanotube ink.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a schematic side view of a transparent heater.

FIG. 2 is a cross-sectional view of a transparent heater positioned for use to heat a reaction vessel.

### DETAILED DESCRIPTION

Examples of the devices, systems, methods and apparatuses discussed herein are not limited in application to the details of construction and the arrangement of components set forth in the following description or illustrated in the accompanying drawings. The devices, systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The following describes a proof-of-concept transparent and conformable heating element that is rated for up to 200° C. at maximum available power of 220 VDC, and has a visible light transmission (VLT), including the substrate, of greater than 60%.

Materials used to fabricate the heating element include a silicone film substrate, which in one non-limiting example is an Elastosil film 2030, 200 microns thick with a PET backer film, available from Wacker Chemie AG, a carbon nanotube (CNT) ink that can withstand temperatures of at least 200° C., and a 50-micron thick copper foil with precoated adhesive on one side to make busbars when bonded over the CNT ink.

Fabrication Process: The CNT ink used was a VC102 ink available from Chasm Advanced Materials, Inc. of Canton Mass., but formulated without a binder so as to increase its stable temperature range to at least 200° C. The silicone substrate was cut from a silicone sheet. One surface was treated with plasma to increase its surface energy. This improves its wettability and allows for a uniformly thick layer of CNT ink to be printed over it, which ultimately provides with a uniform heat distribution on the heater surface. The surface energy improvement was validated by measuring the contact angle of the substrate at various conditions of plasma treatment.

Screen-printing process: The CNT ink was manually screen printed with a 305 polyester mesh screen, using a 70-durometer squeegee. The screen was pre-flooded with ink and then manually printed over the substrate. Two print passes were used to achieve the right sheet resistance of about 700Ω/□. The ink was dried at 110° C. through a conveyorized dryer belt at 7 fpm after each print pass.

Bus Bar attachment: Copper foil tape was manually bonded over both opposed sides of the CNT layer (length-wise) to form busbars. This helped establish good electrical connection between the copper and the CNT.

Lamination Process: The prepared heater film was bonded to a glass substrate so that the heater performance could be tested. Lamination was accomplished with a silicone optically clear adhesive (OCA), using a manual roller. The conductive side of the silicone heater was then laminated to the OCA following a similar process.

In order to laminate to curved or non-flat surfaces to be heated, the substrate with CNT ink and without the busbars can be adhered using the OCA mentioned above. The busbars can then be added. Or, if the busbars are sufficiently flexible, they may be added to the heater element before the heater element is coupled to the surface to be heated. In some examples busbars can be added after coupling to surface if the heater is facing outside, not if it is facing inside. Also, if the heater is facing inside it is preferred to protect the CNT ink from abrasion or impact from external sources, such as with a protective over-layer.

QC Methods: The heater was tested for resistance across the copper busbars using a multimeter. Power to resistively heat the heating element was provided with a variable voltage DC power supply. The temperature and heat uniformity on the heater surface was measured using an IR temperature sensor and FLIR thermal camera.

Results:

Plasma Treatment of the silicone substrate:

Various process parameters were tested to establish the conditions of the plasma treating process to achieve desired substrate properties. See Table 1 and the data below. These process parameters included: distance between plasma nozzle and substrate, travel speed of plasma treater, and jet head plasma width.

Contact angle and sheet resistance measurements were made on 25 μm Wacker silicone substrates to prove out the best process conditions. From Table 1 below it was concluded that 25 mm wide nozzle at medium speed gave good contact angle as well as sheet resistance results.

TABLE 1
Plasma Treatment: two passes

| Plasma | | | | |
|---|---|---|---|---|
| Treatment | Travel | Sheet | | |
| Jet Head | Speed | Resistance | Contact | Print/Film |
| Width (mm) | (in/sec) | (Ω/□) | Angle (º) | Quality |
| 25 | 1 (slow) | 2200 | 10-15 | Warpage of |
| | | | | film |
| 25 | 1.5 (med) | 1700 | 15 | Good |
| 25 | 2.5 (fast) | 3000 | 20 | Good |
| 50 | 1, 1.5, 2.5 | 5000 to 11000 | 15-20 | High Ω/□ |

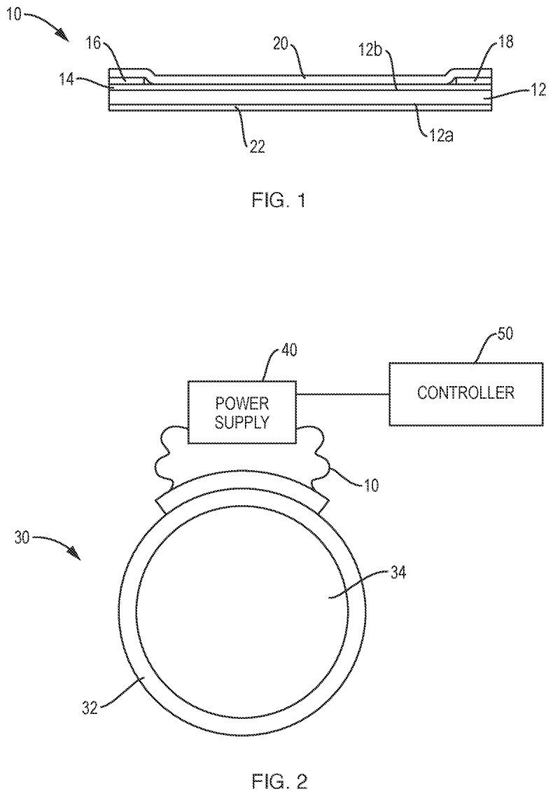

In FIG. 1 (which is not drawn to scale so as to better illustrate the various layers), transparent conformable resistive heating element 10 that is configured to be coupled to a structure to be heated to a predetermined heating range, includes transparent conformable substrate 12 with a lower surface 12a that is configured to be coupled to the structure to be heated and an opposed upper surface 12b. Substrate 12 is stable across the predetermined heating range. A layer 14 of dried carbon nanotube (CNT) transparent conductive ink is on at least some of the upper surface 12b of substrate 12. The transparent conductive ink is stable across the predetermined heating range. A pair of spaced electrodes 16, 18, are each in electrical contact with the transparent conductive ink layer. Also depicted is optional lower clear adhesive layer 22 and optional clear overcoat protective layer 20.

FIG. 2 (which is not drawn to scale) depicts assembly 30 that includes curved reaction vessel 32 with open interior 34. Heating element 10 is coupled to the outside of vessel 32, such as through OCA 22. Variable power supply 40 supplies power to electrodes 16 and 18 under control of control element 50. In order to maintain constant or controlled temperature in reaction volume 34 a temperature sensor (not shown) is used to provide a feedback temperature to control element 50.

Heating Element Test Results:

Sheet resistance, VLT, Haze: Sheet resistance of CNT coating on Heater: 700Ω/□. Total VLT of Heater film (Silicone+CNT+OCA+Glass)=62.6%. Total Haze of Heater film (Silicone+CNT+OCA+Glass)=2.63%. Resistance from bus bar to bus bar: 613Ω.

Temperature on Heater surface: Voltage was gradually increased from 0 to 220 VDC to achieve temperature rise from room temperature to temperature rating of 200° C. At 220V, the surface temperature on heater was greater than 200° C. Voltage can be varied to set the temperature on heater as required.

Temperature Uniformity: Temperature across the heater surface was uniform as measured by a FLIR C3 thermal camera.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A transparent conformable resistive heating element that is configured to be coupled to a structure to be heated to at least a predetermined heating range, comprising:
a transparent conformable substrate with a lower surface that is configured to be coupled to the structure to be heated and an opposed upper surface, wherein the substrate is stable across the predetermined heating range;
a layer of dried carbon nanotube (CNT) transparent conductive ink on at least some of the upper surface of the substrate, wherein the transparent conductive ink is stable across the predetermined heating range; and
a pair of spaced electrodes each in electrical contact with the transparent conductive ink layer.

2. The transparent conformable resistive heating element of claim 1 wherein the substrate comprises at least one of silicone, polyimide, cyclic olefin polymer (COP), polyethersulfone, thermoplastic polyurethane (TPU), and polyethylene naphthalate (PEN).

3. The transparent conformable resistive heating element of claim 2 wherein the upper surface of the substrate is modified to improve its wetting characteristics.

4. The transparent conformable resistive heating element of claim 3 wherein the upper surface of the substrate is modified by corona treatment.

5. The transparent conformable resistive heating element of claim 3 wherein the upper surface of the substrate has a sheet resistance of less than 2000 ohms per square and a contact angle of at least about 15 degrees.

6. The transparent conformable resistive heating element of claim 1 wherein the concentration of CNT in the ink is between about 0.6 g/l and about 2 g/l.

7. The transparent conformable resistive heating element of claim 1 wherein the transparent conductive ink layer has one or more of: a sheet resistance of about 500 to 3000 ohms per square, a thickness of between about 50 nm and about 300 nm, and a visible light transmittance (VLT) of at least about 60%.

8. The transparent conformable resistive heating element of claim 1 further comprising an adhesive on the lower surface of the substrate.

9. The transparent conformable resistive heating element of claim 8 wherein the adhesive is optically clear.

10. The transparent conformable resistive heating element of claim 8 wherein the adhesive has a VLT of from about 85% to about 99%.

11. The transparent conformable resistive heating element of claim 1 wherein the transparent conductive ink layer has a VLT of from about 60% to about 80%.

12. The transparent conformable resistive heating element of claim 1 with a VLT of at least about 50%.

13. The transparent conformable resistive heating element of claim 1 wherein the predetermined heating range is up to about 200° C.

14. The transparent conformable resistive heating element of claim 13 wherein the predetermined heating range is achieved using a variable 220V power supply.

15. The transparent conformable resistive heating element of claim 1 wherein the electrodes are on top of the transparent conductive ink.

16. The transparent conformable resistive heating element of claim 1 further comprising an optically clear cover layer over at least the transparent conductive ink layer.

17. The transparent conformable resistive heating element of claim 16 wherein the optically clear cover layer comprises silicone.

18. The transparent conformable resistive heating element of claim 1 wherein the substrate has a VLT of from about 85% to about 95%.

19. A transparent conformable resistive heating element that is configured to be coupled to a structure to be heated to at least a predetermined heating range of up to about 200° C. that can be achieved with a variable 220V power supply, comprising:
a transparent conformable substrate with a lower surface that is configured to be coupled to the structure to be heated and an opposed upper surface that has a sheet resistance of less than 2000 ohms per square and a contact angle of at least about 15 degrees, wherein the substrate is stable across the predetermined heating range and has a VLT of from about 85% to about 95%;
an optically clear adhesive on the lower surface of the substrate, wherein the adhesive has a VLT of from about 85% to about 99%;
a layer of dried carbon nanotube (CNT) transparent conductive ink on at least some of the upper surface of the substrate, wherein the transparent conductive ink is stable across the predetermined heating range, wherein the concentration of CNT in the ink is between about 0.6 g/l and about 2 g/l, and wherein the transparent conductive ink layer has a VLT of from about 60% to about 80%; and
a pair of spaced electrodes on top of and each in electrical contact with the transparent conductive ink layer;
wherein the transparent conformable resistive heating element has a VLT of at least about 50%.
